(19) United States
(12) Patent Application Publication
(10) Pub. No.: US 2010/0233331 A1
(43) Pub. Date: Sep. 16, 2010

(54) Potato with Enhanced Resistance to Greening and Decay and Infusion Process to Obtain Such Resistance

(76) Inventors: Anthony B. Bello, Plano, TX (US); Brandon Larsen, Carrollton, TX (US)

Correspondence Address: JOHN R LEY, LLC, 5299 DTC BLVD, SUITE 340, GREENWOOD VILLAGE, CO, 80111, US

(21) Appl. No.: 12/402,387

(22) Filed: Mar. 11, 2009

(51) Int. Cl. A23L 3/3454; A23L 1/216

(52) U.S. Cl. 426/281; 426/323; 426/637

(57) ABSTRACT

Greening and decay of potato tubers is inhibited for five or more days of continuous exposure to light, after a treatment mixture comprising effective amounts of natural or ozonated water, food-grade citric acid, food-grade polar lipid or phospholipid emulsifier and food-grade salt has been infused in the potatoes by cyclically dipping and withdrawing the potatoes in a vacuum environment of about 84-90 Kpa less than atmospheric pressure for a time period of about 2-8 minutes.

This invention relates to a new and improved process to inhibit and enhance resistance to greening and decay of fresh-crop and storage-crop potato tubers when exposed continuously to light in packing operations, grocery stores and food markets, thereby prolonging the time that the potatoes are suitable for consumption and sale.

### BACKGROUND OF THE INVENTION

When potatoes are displayed and presented for purchase to customers in grocery stores and food markets, the light in such establishments causes the outer skin of the potatoes to turn a shade of green or yellow-green over time. Greening of fresh-crop or storage-crop potato tubers has been observed after exposure to light continuously for 3 days or less. Fresh-crop potatoes turn green faster than storage-crop potatoes.

Greening is believed to result from the development and formation of chlorophyll pigments in the potato. Light energy is transformed into chemical energy for the conversion of carbon dioxide and water into oxygen, carbohydrates, amino acids, proteins, lipids, pigments, and other components of green tissues. This process is commonly referred to as photosynthesis. The light-induced photosynthetic reactions continue so long as the potato is exposed to light. The level of greening increases with longer exposure to light. The greening is concentrated at the outer skin of the potato within about 2 mm of the surface because it is at this location that light-induced photosynthetic reaction occurs.

The pigments produced during photosynthesis are phenolic compounds including chlorophyll a and chlorophyll b and chlorogenic acid. The typical chlorophyll content of peels from three potato cultivars (White Rose, Russet Burbank and Pontiac) after continuous exposure to light for 5 to 8 days ranges from 3.1 to 6.7 mg/100 g peel. White Rose potatoes exposed to light continuously for 3 to 20 days show intense green color skin as well as significant increases in chlorophyll, chlorogenic acid and glycoalkaloids contents but show no changes in the content of protease enzyme inhibitors.

Customers refuse to purchase potatoes which exhibit greening, under the belief that the vegetable is defective, even though in most cases a minor or moderate level of greening does not detract from the food value of the potato or make the potato unfit for human consumption. However, greening may alter the taste of the potato due to the formation of glycoalkaloids (α-chaconine and α-solanine) during photosynthesis. Extreme levels of glycoalkaloids formation in green potatoes do substantially alter the taste or even become mild bodily irritants in some circumstances. Glycoalkaloids and chlorophyll develop in the same region of the tuber, but chlorophyll is tasteless and harmless. The glycoalkaloids are potent cholinesterase inhibitors.

Food market operators adjust the display and supply of potatoes to minimize exposure to continuous light and thereby minimize greening of potatoes at the point of sale. Generally speaking, a food market operator will display only those potatoes which are likely to be purchased within approximately 24 hours. To do so, the food market operator must continually change and rotate the potatoes offered for sale. A fresh supply of potatoes is required on a day-to-day basis. The potatoes must be sold as quickly as possible before greening begins. Continually rotating the potatoes increases the costs of selling potatoes. The daily transportation costs also increase the price of potatoes to consumers. In general and despite the efforts to rotate the stock of potatoes, approximately 10% of the potatoes distributed for retail sale are lost as unsalable due to greening. Losing potatoes to greening increases the cost of potatoes and reduces the supply of food available for consumption, including loss of potatoes due to disposal by consumers when greening occurs at home.

Because of its significant negative impact, many attempts have been made to inhibit or eliminate greening in potatoes and to enhance resistance of potatoes to greening.

One approach to attempting to inhibit greening in potatoes is to market the potatoes in a dirty condition, such as by leaving some of the soil attached to the outer skin of the potato when presented to the customer. The soil acts as a barrier to light entering the skin of the potato. A related technique is to spray the outer layer of the potatoes with a thin coat of mud. An outer layer of a wax-like or resin-like barrier material has also been sprayed over potatoes, to create a gas transfusion barrier to prevent carbon dioxide from entering the potato and oxygen created by photosynthesis from escaping from the potato. Creating the gas barrier rate-limits the ability of the potato to photosynthesize, thereby slowing the greening. However, this technique is prone to cause rot or decay of the potatoes.

Leaving or adding exterior barrier coatings is generally regarded as unsatisfactory by the customer, because the barrier coating material obscures the underlying quality of the potato. The usual customer desires to evaluate the potato visually before making a purchasing decision. The exterior coating also requires extra work to remove the outer coating when preparing the potato for consumption. Such barrier coatings are easily disrupted by contact of the potatoes with each other during transportation and display.

Customers are also unwilling to accept potatoes wrapped in opaque paper or other covering material, because customers insist on unwrapping the potatoes to visually examine them before purchase. Once unwrapped, the customer is unlikely to rewrap the potatoes in the grocery store or food market. The unwrapped potatoes are then exposed to light. Wrapping the potatoes individually also adds to the cost of marketing and distribution.

Another attempt to inhibit greening of potatoes involves submerging the potatoes in water for a long period of time to create temporary anoxia (lack of oxygen). The potatoes must be submerged in water for a minimum of 5 to 10 days to prevent greening and glycoalkoloid formation. A refinement to this technique involves a pre-anoxia vacuum treatment. Potatoes are subject to vacuum at 120 mm Hg for 3 minutes to remove small air bubbles adhering to the skin of the tubers before submerging them in water for at least the next 5 days to create the temporary anoxia. However, vacuum pretreatment before temporary anoxia has resulted in potato decay at 4 days of continuous exposure to light. Furthermore, vacuum pretreatment did not differ from anoxia treatment alone in inhibiting chlorophyll and glycoalkaloid formation. Submerging potatoes in water for long periods of time requires more processing, more equipment, creates many logistical handling problems and generally increases the price of potatoes to consumers.

Another anoxia treatment packages the potatoes in a hermetic envelope containing nitrogen or carbon dioxide gas. The nitrogen and oxygen gases deprive the potato of carbon dioxide to inhibit greening. However, this modified atmosphere packaging is considered unsatisfactory due to sealing difficulties of the packaging film and the increased cost of maintaining a controlled atmosphere in potato packing operations.

In addition to greening, customers are deterred from purchasing potatoes which exhibit decay, rot, spoilage and soft spots. In general, the decay, rot, spoilage and soft spots, collectively referred to below as “decay,” generally results from bacteria, mold or other microorganisms penetrating through a bruised spot in the skin of the potato and growing within the body of the potato. Bruised spots on potatoes are almost inevitable, because of the amount of handling that the potatoes receive during harvesting, transportation and display. Microorganisms naturally exist on the skin of the potato and are thus readily available to begin growing at the bruised spots and create the decay. In general, decay also progresses, or progresses more rapidly, in the presence of light.

Different types of chemical treatment processes have also been applied to attempt to inhibit greening and/or decay. Most of these chemical treatment processes involve spraying or brushing the potatoes with, or dipping the potatoes in, an aqueous solution containing various chemical constituents that are claimed to have an inhibiting effect on greening and decay. Typical chemical constituents used in such processes include a wide variety of acids and salts of both natural and synthetic origin. Wetting or emulsifying agents are sometimes added to such solutions.

U.S. Pat. No. 4,123,558 describes treating potatoes to inhibit greening by spraying or dipping the tubers in an aqueous mixture consisting essentially of up to 15% each of a food-grade emulsifier and an organic acid. Effective high concentrations are likely to create a negative taste, and also add to processing complexity, cause costly implementation and result in more rapid development of rot and decay.

U.S. Pat. No. 3,533,810 describes the prevention of potato greening by using chemicals which are not commonly found or used in foods to prevent greening of potatoes. Methyl anthranilate, methyl p-hydroxy benzoate and propyl p-hydroxy benzoate and mixtures thereof are used in addition to 1.0 to 15% by weight lecithin and 4.0 to 15% by weight of an emulsifying agent other than lecithin. The use of emulsifiers and acids at these high concentrations is likely to create a strong and objectionable negative taste in addition to higher implementation cost and more rapid decay.

In general, the chemical constituents used in many treatment solutions are not commonly used in foodstuffs. Even though the chemical constituents are regarded as safe or suitable for human consumption, they typically introduce an unnatural or unusual taste to the potatoes, which is likely to cause customers to refuse to repeat-purchase such treated potatoes because of their taste. Furthermore, the costs of such chemical constituents and the treatment processes to apply them may outweigh any perceived benefit. Furthermore, some of the chemical constituents of non-greening treatment solutions may actually contribute to accelerated decay.

The prior attempts to inhibit greening and decay have not been successful from a treatment standpoint, or have been too complex or costly to implement, or have failed to provide sufficient additional benefit to outweigh or overcome the additional costs and difficulties associated with the decay and continual rotation of the supply of potatoes in food markets. Despite prior attempts to avoid the problem, greening and decay of potatoes still persists on a widespread commercial basis.

### SUMMARY OF THE INVENTION

The present invention involves the discoveries that greening and decay in potatoes can be substantially inhibited or retarded for a considerable period of time, at least 5 days, and that any greening and decay that ensues during a reasonable time thereafter can be held to a such minor level to avoid discouraging customers from purchasing the potatoes for an extended shelf-life in grocery stores and food markets. The present invention involves a straightforward, simple-to-execute and relatively inexpensive treatment process which adds minor additional cost to the potatoes, and that minor additional cost is at least partially counterbalanced by less potato loss due to greening and decay.

The invention inhibits greening of whole potato tubers by vacuum infusion of an aqueous treatment mixture which includes effective concentrations of a food-grade emulsifier, a food-grade organic acid and a food-grade salt. The vacuum infusion occurs by cyclically dipping the potatoes in and out of the treatment mixture for an effective time period in an effective vacuum. The treated potatoes remain non-green in color when exposed to light continuously for a period of at least 5 days and typically longer. The treated potatoes also show no sign of decay for a period of at least 5 days and typically longer.

An exemplary and effective aqueous treatment mixture consists essentially of either natural or ozonated water and effective amounts of about 0.5-1.4% emulsifier, 0.9-2.1% citric acid and 0.4-1.1% salt, all by weight. The use of emulsifier, citric acid and salt in an aqueous treatment mixture which is outside of the preferred range has been found ineffective in preventing greening, or has been found to promote decay. The most preferred composition of the treatment mixture consists of effective amounts of about 0.7-0.9% emulsifier, 1.2-1.4% citric acid and 0.5-0.8% salt, all by weight in either natural or ozonated water. The preferred infusion of the treatment mixture occurs in a vacuum environment of about 84-90 Kpa (24.8-26.6 inches Hg at 32° F.) less than ambient air pressure. Preferably, the potatoes are cyclically dipped in 8 second cycles in the treatment mixture for a total time period of about 2-8 minutes, preferably 4 minutes. This typically infuses the treatment mixture into the potato to a depth of 1-3 mm from its surface. Treated in this manner, the potatoes do not turn green and do not decay for at least 5 days, under continuous exposure to light and simulated potato handling and cold and display storage conditions of 45-75° F. (7-24° C.) and 30-90% relative humidity (RH).

The vacuum infusion permits reduced concentrations of emulsifier and organic acid in the treatment mixture. Higher concentrations of emulsifier (1.5% or greater) and citric acid (2.2% or greater) cause a more rapid development of decay or soft spots in the treated potatoes, although effective inhibition of greening does occur with these higher concentrations of emulsifier and citric acid. A concentration of emulsifier of less than about 0.5%, citric acid of less than about 0.9% and table salt of less than about 0.3%, also shortens the development time for decay of non-greening potatoes. Vacuum infusion of potatoes in water alone, or in a mixture of water and about 1.4% citric acid and about 0.8% table salt, or in a mixture of water and 1.0-2.0% emulsifier, did not inhibit or retard greening of potatoes when exposed to light continuously for at least 3 days or longer. Similar results were observed at about 0.5% emulsifier and 1.0% citric acid concentrations. Also, it has been observed that potatoes which experience greening usually do not decay, but potatoes with inhibited greening are susceptible to decay.

Another aspect of the invention is a fresh-crop potato or a storage-crop potato which has been treated as described above to inhibit greening and decay when exposed to light continuously for 5 days or longer.

Other aspects of the invention and a more complete appreciation of the present invention, as well as the manner in which the present invention achieves the above and other improvements, can be obtained by reference to the following detailed description of presently preferred embodiments taken in connection with the accompanying drawings, which are briefly summarized below, and by reference to the appended claims.

### BRIEF DESCRIPTION OF THE DRAWINGS

FIG. 1 is a flow chart illustrating a basic treatment process for inhibiting greening of potatoes, in accordance with the present invention.

FIG. 2 is a diagrammatic cross-sectional illustration of a potato which has been treated in accordance with the process shown in FIG. 1.

FIG. 3 is a perspective view of one example of apparatus which may be used in practicing aspects of the process shown in FIG. 1, in which some parts of the apparatus is shown exploded and other parts of the apparatus are shown broken away.

FIG. 4 is a vertically-sectioned side view of the apparatus shown in FIG. 3, with a portion broken away, illustrating one position of the potatoes during treatment with the process shown in FIG. 1.

FIG. 5 is a vertically sectioned side view similar to FIG. 4, illustrating another position of the potatoes during treatment with the process shown in FIG. 1.

FIG. 6 is a flowchart illustrating formulation of a treatment mixture used in the process shown in FIG. 1.

### DETAILED DESCRIPTION

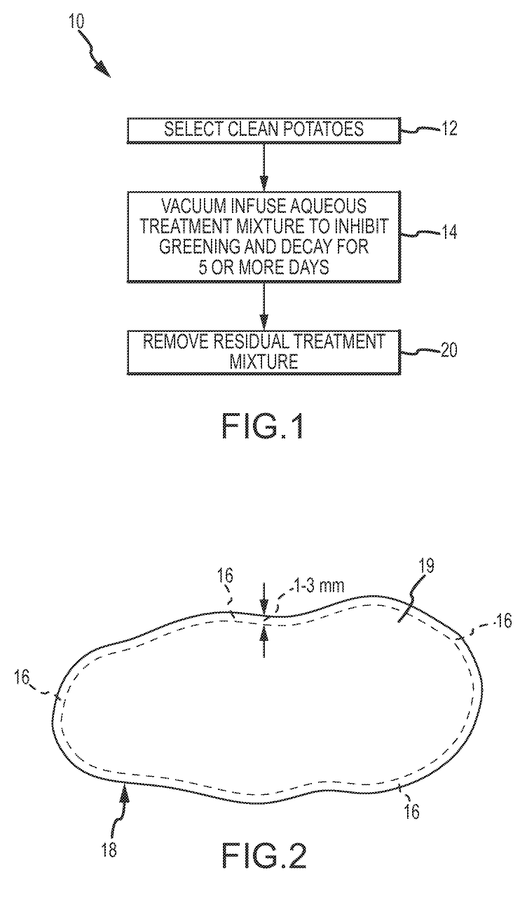

A basic process 10 for treating potatoes to inhibit greening is shown in FIG. 1. The process 10 begins with selecting a batch or load of cleaned fresh-crop or storage-crop potatoes, shown at 12. The selected potatoes should be substantially free of all surface debris and residual dirt. Next, shown at 14, an aqueous treatment mixture is infused into the potatoes. As described in greater detail below, the aqueous treatment mixture is formed by regular or ozonated water and effective amounts of food-grade emulsifier, food-grade citric acid and food-grade salt. The infusion is preferably achieved in a vacuum environment.

The treatment mixture is infused to a 1-3 mm depth from the outer surface or skin of the potato 18, as shown by the layer 16 in FIG. 2. It is believed that the infused treatment mixture modifies the photosynthetic-reactive characteristics of the potato in the layer 16 to form a barrier which inhibits photosynthesis and decay. The barrier layer 16 prevents light from reaching the uninhibited interior portion 19 of the potato 18. Without light, the uninhibited interior portion 19 of the potato 18 will not undergo photosynthesis, and consequently the interior portion 19 will not contribute to greening of the potato. In a related manner, the barrier 16 inhibits the growth of microorganisms, bacteria, mold and the like, thereby inhibiting decay. Infusing the treatment mixture into the 1-3 mm layer 16 is sufficient to inhibit photosynthesis and prevent greening and decay for at least 5 days after continuous exposure to light. In many cases, the inhibition to greening and decay continues for a longer amount of time. The extent to which greening is inhibited is believed to be directly related to whether greening has started, even to a somewhat minor degree, before the potato is subjected to the process 10 (FIG. 1).

Finally after the potatoes have been treated at 14, residual surface remnants of the aqueous treatment mixture are removed from the surface of the potatoes, as shown at 20 in FIG. 1. Thereafter, the treated potatoes destined for cold storage are stored at a temperature of 45-55° F. (7-13° C.) in cartons or polybags or totes and thereafter distributed to food markets and grocery stores for purchase by customers. Preferably, the treated potatoes are shielded from light while in storage and transit to the food markets and grocery stores, to avoid exposing the treated potatoes to continuous light before the potatoes are displayed for purchase. The treated potatoes may also be delivered immediately for display at grocery stores and food markets at a temperature of about 70-75° F. (21-24° C.). Treated in this manner, the potatoes will resist greening and decay when displayed for purchase by customers for a period of 5 or more days of continuous exposure to light.

The process 10 applies equally to fresh-crop potatoes and storage-crop potatoes. A fresh-crop potato is one which is harvested, farm washed, packaged and distributed for sale, under circumstances where the potato is placed on sale within 21 days of harvesting. A storage-crop potato is one which is harvested and suberized (a sweating and respiration process) for a period of at least 21 days before packing and distribution for sale. As well as preservation, suberization allows for healing of potato skin damage and other minor damage to potato that may have occurred during harvest and farm washing operations.

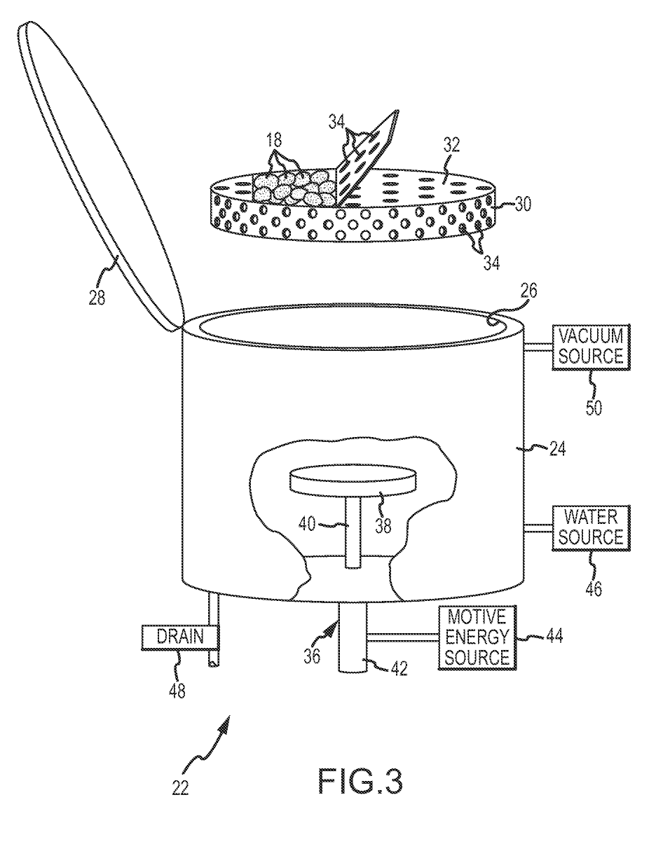

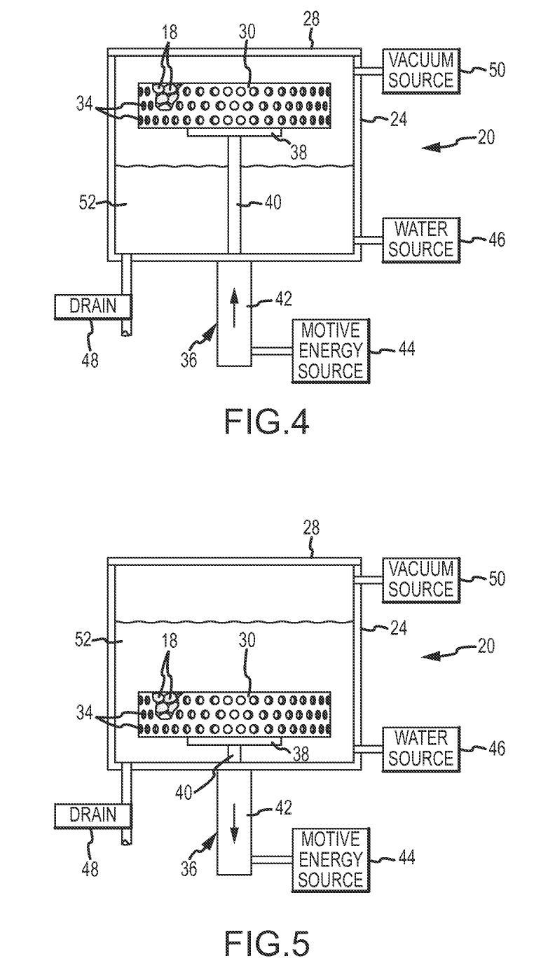

One example of apparatus 22 which may be used to treat the potatoes with the process 10 (FIG. 1) is generally illustrated in FIG. 3. Other types of equipment may also be used, such as a conventional vacuum tumbler. The apparatus 22 includes a large container 24 which is closed except at a top opening 26 into the container 24. A lid 28 is hinged to the container 24 adjacent the top opening 26, and can be positioned to open the interior of the container 24, as shown in FIG. 3, or positioned to close and seal the container 24 as shown in FIGS. 4 and 5.

A basket 30 is insertable through the top opening 26 into the interior of the container 24. The basket 30 is closed except at hinged doors 32. Before treatment, the interior of the basket 30 is loaded with the batch of potatoes 18. Opening the hinged doors 32 allows potatoes 18 to be inserted into the basket 30. Openings 34 are formed through the basket 30 to allow the aqueous treatment mixture to penetrate through the basket and contact and surround the exterior of the potatoes 18 confined within the basket 30.

The basket 30 is supported within the container 24 on an elevator mechanism 36 that includes a support plate 38 upon which the basket 30 rests (FIGS. 4 and 5). A shaft 40 is connected to the support plate 38 and extends through an opening in the bottom of the container 24. An actuator 42 is connected to the shaft 40 on the outside of the container 24. A source of motive energy 44 causes the actuator 42 to vertically extend and retract the shaft 40 (FIGS. 4 and 5). As the shaft 40 moves vertically, the support plate 38 and the basket move vertically within the container 24. The actuator 42 may be a conventional piston and cylinder assembly, and the source of motive energy 44 may be hydraulic or pneumatic pressure which moves the piston within the cylinder assembly, thereby moving the shaft 40. Other types of actuators and motive energy sources may be employed.

A source 46 of water is connected to the container 24. Water from the source 46 enters the interior of the container 24 to create the aqueous treatment mixture within the container 24. The water from the source 46 fills the bottom portion of the container 24. The chemical constituents of the treatment mixture are preferably added into the container 24, and are distributed and mixed with the water in the container 24. Alternatively, a pre-mixed treatment mixture could be added to the container 24. The aqueous treatment mixture remains in the container 24 for the duration of treatment process applied to least one batch of potatoes 18 confined within the basket 30. In some circumstances, a single treatment mixture in the container 24 may be used to treat multiple batches of potatoes 18. When the treatment mixture is no longer deemed effective, a drain 48 is opened to remove the spent treatment mixture from the container 24. A fresh treatment mixture is thereafter prepared and used for treating subsequent batches of potatoes.

Treatment of the potatoes 18 occurs after the treatment mixture has been formulated and the basket 30 filled with potatoes 18 has been positioned upon the support plate 38. The lid 28 is closed and preferably locked to seal the top opening 26 of the container 24. A vacuum source 50 is connected through the container 24 at an upper location within the interior of the container 24. The vacuum source 50 creates a low pressure environment within the interior of the closed container 24. The low pressure environment is substantially less than ambient air pressure, preferably in the range of 84 to 90 Kpa (24.6-26.6 inches of mercury (Hg) at 32° F.) less than ambient air pressure. The low pressure environment assists in infusing the treatment mixture into the surface of the potatoes 18.

Treatment of the potatoes is generally illustrated in FIGS. 4 and 5. The treatment mixture described above is shown at 52 within the container 24. The treatment mixture 52 is present in the container 24 before the basket 30 filled with potatoes 18 and inserted into the container 24. The treatment mixture 52 generally occupies more than the lower volumetric half of the container 24. The elevator mechanism 36 vertically extends the support plate 38 to an upper position shown in FIG. 4. In this upper position, the support plate 38 is readily available to connect with and receive the basket 30 filled with potatoes 18.

After the basket 30 of potatoes 18 is positioned on the support plate 38, the lid 28 is closed as shown in FIG. 4. The reduced pressure environment created by the vacuum source 50 is thereafter created in the interior of the closed container 24 above the level of the treatment mixture 52. Although the pressure on the treatment mixture 52 within the interior of the closed container 24 is reduced by the vacuum source 50, the major effect of the reduced pressure environment exists above the level of the treatment mixture 52. Within the treatment mixture 52 itself, the effects of the reduced pressure environment from the vacuum source 50 are diminished because of the volumetric density of the treatment mixture 52.

The elevator mechanism 36 and the motive energy source 44 lower the basket 30 filled with potatoes 18 into the treatment mixture 52, as shown in FIG. 5. The openings 34 in the basket 30 allow the treatment mixture 52 to completely surround all the potatoes 18. The quantity of treatment mixture 52 in the container is sufficient to completely submerge the potatoes 18 in the basket 24 when the elevator mechanism 36 moves the support plate 38 to the downward position shown in FIG. 5. The vacuum source 50 communicates with the closed container 52 at a position above the level of the treatment mixture 52 when the basket 24 with the potatoes 18 is completely submerged, thereby permitting the vacuum source 50 to maintain a continuous low pressure within the interior of the container 24 during treatment of the potatoes.

A preferred form of treating the potatoes is to repeatedly submerge or dip the potatoes in the treatment mixture 52, as shown in FIG. 5, and then withdraw the potatoes from the treatment mixture 52, as shown in FIG. 4. By repetitively submerging the potatoes within the treatment mixture and then withdrawing the potatoes from the treatment mixture in a cyclical manner, the evacuated environment within the closed container 24 facilitates the infusion of the treatment mixture 52 into the potatoes 18 to the 1-3 mm depth of the exterior layer 16 (FIG. 2).

When the potatoes are submerged within the treatment mixture 52, the higher pressure caused by the higher density treatment mixture isolates the reduced pressure created by the vacuum source 50 and forces or infuses the treatment mixture into the body of the potatoes. When the potatoes are withdrawn from the treatment mixture 52, the lower pressure created by the vacuum source becomes fully effective on the potatoes when the potatoes are withdrawn from the treatment mixture 52. The lower pressure tends to withdraw the treatment mixture from the body of the potato. The infusion of the treatment mixture to the 1-3 mm depth of the exterior layer 18 (FIG. 2) is facilitated by subjecting the potatoes to the repetitiously-changing different pressure environments. Repetitiously changing the pressure on the potato forces the treatment mixture into the surface of potato in a relatively short amount of time.

Preferably, the amount of time that the potatoes remain submerged in the treatment mixture 52 is approximately 3 seconds, and the amount of time that the potatoes remain withdrawn from the treatment mixture 52 is also approximately 3 seconds. Approximately one second is required to transition between the submerged and withdrawn positions. Consequently, the potatoes are dipped into and out of the treatment mixture 52 in 8 second cycle times. The potatoes are submerged and withdrawn in the manner described for a total batch treatment time of about 2-8 minutes, with a total treatment time of about 4 minutes typically yielding satisfactory results in a reduced pressure environment of 84-90 Kpa. During this total treatment time, the potatoes are submerged for approximately half of the time and exposed to the low pressure environment for the other half of the time. The infusion time is about equally divided between submersion in the treatment mixture and exposure to the low pressure environment. Treating the potatoes in this manner results in infusion of the treatment mixture into the 1-3 mm layer 16 (FIG. 2).

At the conclusion of the treatment illustrated by FIGS. 4 and 5, the evacuated environment in the closed container 24 is ended by opening a valve associated with the vacuum source 50, thereby relieving the reduced pressure environment within the container 24. The lid 28 is opened to the position shown in FIG. 3, and the basket 30 containing the treated potatoes 18 is removed through the top opening 26.

The treated potatoes 18 are removed from the basket and residual or remnant amounts of the treatment mixture are removed, as shown at 20 in FIG. 1. Removing residual treatment mixture from the exterior surface of the potatoes 18 is accomplished by still air drying or by a combination of still air drying and airflow movement over the treated potatoes 18 and by cold storage at 45-55° F. (7-13° C.). Other types of moisture removal techniques may be employed, so long as the removal technique displaces the visually-apparent residual treatment mixture that may remain present on the potatoes 18 after treatment.

Once dried, the treated potatoes are stored and/or packaged and transported to food markets and grocery stores. The potatoes may be confined in individual wraps, in boxes or bags which each contain multiple potatoes, or in relatively large bulk-size bags which contain many hundreds or thousands of potatoes.

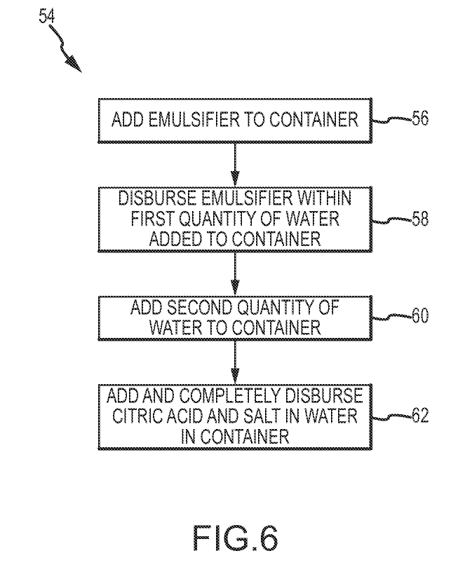

Details concerning the preparation of the treatment mixture 52 which is infused into the potatoes is illustrated by the process 54 shown in FIG. 6. The preparation process 54 is described in conjunction with the treatment apparatus 22, although appropriate modifications will be required depending upon the type of treatment apparatus used.

Preferably, the first step in the process flow 54 is to add the food-grade emulsifier to the container 24, as shown at 56. The amount of emulsifier added at 56 is that amount which will result in the desired concentration of the emulsifier in the final treatment mixture. Emulsifiers which have proved satisfactory for purposes of the present invention are Thermolec WFC lecithin and Yelkin 1018 lecithin, both manufactured by Archer Daniels Midland Co. of Decatur, Ill.; Aldo MO emulsifier, manufactured by Lonza Group, Williamsport, Pa.; and Polysorbate 80, supplied by Sigma Aldrich, St. Louis, Mo. A mixture of Aldo MO and Polysorbate 80 in equal parts, or a mixture of Aldo MO and lecithin in equal parts, has also proved satisfactory. These polar lipids and phospholipids emulsifiers are commonly used in modern food products, and consumers are used to the taste of these emulsifiers in potato-based food products such as dehydrated potato flakes, granules and flanules, and in baked and fried potato crisps snacks. Use of these emulsifiers does not create an unusual or different taste of the treated potatoes. Preferably, the emulsifier used to create the treatment mixture is in liquid form.

It is important that the liquid emulsifier is thoroughly and completely mixed and dispersed within the water when forming the treatment mixture. An effective technique of doing so is to add a first quantity of water to the container 24 (FIG. 3) after which the emulsifier is added to the container, as shown at 58. The first quantity of water is preferably hot water, for example water having a temperature of 140-150° F. (66-68° C.). The elevated temperature helps disperse the emulsifier within the water. A heater (not shown) may be part of the water source 46 (FIGS. 3-5) and used to elevate temperature of the water to the desired level to facilitate disbursement of the emulsifier within the water. The first quantity water may be approximately 25%-33% of the total amount of water added to the container to create the treatment mixture.

The first quantity of water added at 58 is preferably added in such a way that it continually agitates and disperses the polar lipids or phospholipids emulsifiers. The heat from the water and the continual stirring and agitating action effectively disperses the emulsifier throughout the first quantity of water. The stirring, agitation and disbursement from the addition of the first quantity of water may be supplemented by additional manual or mechanical stirring or agitation. Ultimately the emulsifier must be thoroughly and uniformly dispersed within the first quantity of water at 18.

Next at 60, a second quantity of water is added to the container. The second quantity of water is the remaining amount of water necessary to create the desired volume of water in the aqueous treatment mixture. The second quantity of water may be of a reduced temperature so that the resulting treatment mixture will have a final temperature of approximately 105-120° F. (40-49° C.) during the treatment of the potatoes, and more preferably a temperature of 110-115° F. (43-46° C.). The cooler water added at 60 is also preferably introduced in a way that it continually dilutes the uniform mixture of emulsifier created at 58, resulting in the emulsifier being thoroughly mixed with all the water in the container after the second quantity of water has been added at 60. In general, the amount of the second quantity of water added is approximately 67-75% of the total amount of water of the aqueous treatment mixture.

The second quantity of water may also be at a relatively high temperature, but it has been discovered that a temperature of the treatment mixture in the range of approximately 140-170° F. (54-77° C.) causes significant shrinkage, wrinkling and apparent pin holes in the skin of the treated potatoes, within 24 hours after treatment. The shrinkage, wrinkling and pin holes diminish the salability of the potatoes, even without greening or decay.

The water added at 58 and 60 may be commercially available tap water, distilled water, or ozonated water. Ozonated water is tap or distilled water to which ozone has been added so that the resulting treatment mixture has a final concentration of ozone of 0.0005 to 0.001 parts per million (ppm). The ozonated water appears to have the beneficial effect of killing or reducing the number of microorganisms that might create decay in the potatoes.

Next food-grade citric acid and food-grade salt are added to the water in the container to complete formulation of the treatment mixture. The citric acid and the salt are thoroughly and uniformly distributed in the water and emulsifier, as shown at 62. The citric acid and salt may be added after the second quantity of water has been added at 20, or the citric acid and salt may be added as the second quantity of water is added at 60. In either event, adding the citric acid and salt after the emulsifier has been distributed within the water eliminates or substantially retards the precipitation of the emulsifier from the treatment mixture. Sometimes, adding the citric acid and salt before adding the emulsifier precipitates a considerable amount of the emulsifier from the treatment mixture and consequently results in less effectiveness of the emulsifier in the treatment mixture. Preventing precipitation of the emulsifier from the treatment mixture is important in keeping the effective concentration of the emulsifier at its desired level, and reduces the amount of emulsifier needed in the treatment mixture.

The emulsifier plays a significant role in the treatment process of inhibiting the photosynthetic reaction in the external layer 16 of the potato 18 (FIG. 2). The emulsifier is a treatment agent in the treatment mixture, in addition to performing an emulsification function. An inadequate amount of the emulsifier in the treatment mixture results in substantially less greening-inhibiting effect in potatoes, even when the same amount of citric acid and salt are present in the treatment mixture.

Preferably both the citric acid and the salt are added to the water at 62 as granules or powder. Food-grade citric acid is conventional and available from a number of commercial sources, such as Sigma Aldrich. Other types of suitable citric acid are carboxylic acids of malic or monopotassium salt of tartaric acid. Suitable food-grade salt may also assume a number of different forms. The preferred form of the salt is conventional table salt supplied by Morton Company. Other forms suitable sources of salt are calcium chloride salt and potassium chloride salt. The salt in the aqueous mixture of emulsifier and organic acid minimizes any potential negative impact of the emulsifier and/or organic acid on the taste of the potatoes.

The amount of polar or phospholipid type emulsifier in the final treatment mixture should be in the range of 0.5-1.4% by weight, with a more preferable amount in the range of 0.5-1.1% by weight, and the most desirable amount being 0.7-0.9% by weight. The amount of citric acid added at 62 should result in the final treatment mixture having a citric acid content in the range of 0.9-2.1% by weight, with a more preferable amount in the range of 0.9-1.4% by weight, and with the most desirable range being 1.2-1.4% by weight. The amount of salt added at 62 should result in the final treatment mixture having a salt content in the range of 0.4-1.1% by weight, with a more preferable amount in the range of 0.4-0.8% by weight, and with the most desirable amount being 0.5-0.8% by weight. Once the treatment mixture 52 (FIGS. 3-5) has been formulated in this manner, the potatoes 18 are treated in accordance with the treatment process 10 described above and shown in FIG. 1.

Preferably, the potatoes selected for treatment at 12, shown in FIG. 1, have been initially washed or cleaned with ozonated water. Preferably, the ozonated water used in cleaning the potatoes contains ozone in the amount of 0.0005 to 0.001 ppm. The ozonated water has the effect of destroying or inhibiting surface microorganisms which cause decay. The ozonated water use to clean the potatoes before treatment also appears to permit more effective interaction of the treatment mixture with the potatoes.

The utility and effectiveness of the present invention in preventing greening of potatoes is illustrated by the following Examples. In each Example, a batch of about 16-50 potatoes (USDA No. 1, Size A (˜9 ounce)) was tested. Potatoes of the Russet species were tested, as well as potatoes having white skin color and golden color otherwise known as White potatoes and Yukon Gold potatoes, respectively. Before performing the treatment process, the potatoes selected for treatment were washed with ozonated water and allowed to dry.

In each of the following Examples, vacuum infusion was accomplished by use of the vacuum infusion equipment shown and described in conjunction with FIGS. 3-5. Such equipment is manufactured by Grow-Vac of Pine Bluff, Ark., but is intended primarily for use in conditioning meat food products. The vacuum created was in the range of 84-90 Kpa (24.8-26.6 inches Hg at 32° F.) less than ambient air pressure. The treatment time in each Example was about four minutes.

In those Examples using ozonated water, that ozonated water had a final concentration of 0.0005 to 0.001 parts per million (ppm) ozone. The weight proportions of emulsifier, citric acid and salt are described in connection with each Example. The type of emulsifier used in each Example is also identified.

After treatment, the residual treatment mixture was removed and the potatoes were allowed to dry. Thereafter, the treated potatoes were continuously exposed to fluorescent light of the type conventionally used at point-of-sale displays in food markets and grocery stores, to evaluate greening and decay. Elapsed time was measured commencing with the initial exposure to the fluorescent light. Examinations of each potato for signs of greening and decay were made at different elapsed times.

The extent of greening, if any, was recorded as “non-green,” when no greening was observed on the surface of the potatoes or when a slight light green or yellow-green color or cast appeared on the surface of the potatoes but the extent of the light green or light yellow-green color was judged insufficient to cause a consumer not to purchase the potatoes; and was recorded as “green,” when clear and abundant green color appeared on the surface of the potatoes to such an extent that a customer would not have purchased the potatoes in the normal course of events. Decay was determined by physical examination using both hands to press firmly into the potato to expose any soft spots or mushy tissue, and by visual examination to identify substantially discolored surfaces.

No green was observed in any of the potatoes treated in the following Examples after 5 days of continuous exposure to the light. None of the non-green potatoes treated in Examples 1-5 and 9-12 developed any signs of decay for at least 5 or more days after continuous exposure to light. The potatoes treated in Examples 6-8 developed decay after 5 days within a 5-8 day time period. The potatoes treated in Examples 1-3 and 12 did exhibit a very faint green or yellow-green within the 5 day time when continuously exposed to light, but that very faint green or yellow-green color was judged insufficient to discourage a consumer from purchasing the potatoes. One observation arising from this invention is that potatoes which experienced greening usually do not decay. Only those potatoes with inhibited greening appeared susceptible to decay.

### EXAMPLE 1

| Treatment Mixture | Weight % |
|---|---|
| Salt | 0.5 |
| Thermolec WFC Lecithin Emulsifier | 0.7 |
| Anhydrous Citric Acid | 0.9 |
| Regular Water | 97.9 |

### EXAMPLE 2

| Treatment Mixture | Weight % |
|---|---|
| Thermolec WFC Lecithin Emulsifier | 0.7 |
| Salt | 0.8 |
| Anhydrous Citric Acid | 1.3 |
| Regular Water | 97.2 |

### EXAMPLE 3

| Treatment Mixture | Weight % |
|---|---|
| Aldo MO Emulsifier | 0.7 |
| Salt | 0.5 |
| Anhydrous Citric Acid | 0.9 |
| Regular Water | 97.9 |

### EXAMPLE 4

| Treatment Mixture | Weight % |
|---|---|
| Aldo MO Emulsifier | 0.7 |
| Salt | 0.8 |
| Anhydrous Citric Acid | 1.3 |
| Regular Water | 97.2 |

### EXAMPLE 5

| Treatment Mixture | Weight % |
|---|---|
| Polysorbate 80 Emulsifier | 0.7 |
| Salt | 0.8 |
| Anhydrous Citric Acid | 1.3 |
| Regular Water | 97.2 |

### EXAMPLE 6

| Treatment Mixture | Weight % |
|---|---|
| Salt | 0.8 |
| Anhydrous Citric Acid | 1.3 |
| Thermolec WFC Lecithin Emulsifier | 1.4 |
| Regular Water | 96.5 |

### EXAMPLE 7

| Treatment Mixture | Weight % |
|---|---|
| Salt | 0.8 |
| Anhydrous Citric Acid | 1.3 |
| Yelkin 1018 Lecithin Emulsifier | 1.4 |
| Regular Water | 96.5 |

### EXAMPLE 8

| Treatment Mixture | Weight % |
|---|---|
| Salt | 0.8 |
| Anhydrous Citric Acid | 1.3 |
| Thermolec WFC Lecithin Emulsifier | 1.4 |
| Ozonated Water | 96.5 |

### EXAMPLE 9

| Treatment Mixture | Weight % |
|---|---|
| Salt | 0.8 |
| Anhydrous Citric Acid | 1.3 |
| Aldo MO Emulsifier | 1.4 |
| Ozonated Water | 96.5 |

### EXAMPLE 10

| Treatment Mixture | Weight % |
|---|---|
| Salt | 0.8 |
| Anhydrous Citric Acid | 1.3 |
| Yelkin 1018 Lecithin Emulsifier | 1.4 |
| Ozonated Water | 96.5 |

### EXAMPLE 11

| Treatment Mixture | Weight % |
|---|---|
| Thermolec WFC Lecithin Emulsifier | 0.5 |
| Salt | 0.8 |
| Anhydrous Citric Acid | 1.4 |
| Regular Water | 96.4 |

### EXAMPLE 12

| Treatment Mixture | Weight % |
|---|---|
| Salt | 0 |
| Thermolec WFC Lecithin Emulsifier | 0.7 |
| Anhydrous Citric Acid | 2.2 |
| Regular Water | 97.1 |

To further understand the extent of the present invention, greening of the potatoes was not inhibited or eliminated after 5 days of continuous exposure to light when the potatoes were vacuum infused in water alone; or in a treatment mixture of water, 1.3% citric acid and 0.8% table salt; or in a treatment mixture of water and about 1.4% WFC lecithin emulsifier or about 1.4% Yelkin 1018 lecithin emulsifier or about 1.4% Aldo MO emulsifier or about 1.4% Polysorbate 80; or in a treatment mixture of water and 2.1% emulsifier without the addition of an organic acid and salt.

The effectiveness of lower concentrations of emulsifiers appears to correspond to a lower hydrophilic-lipophilic balance (HLB) rating of the emulsifiers. For example, ALDO MO (HLB˜3) was more effective than Yelkin Lecithin 1018 (HLB˜9) or Thermolec WFC Lecithin (HLB˜11). However, emulsifier and citric acid concentrations of less than or equal to about 1.0% shortened the development time for decay of non-greening potatoes.

A glossy or almost oily appearance occurred on some of the non-greening potatoes. This appearance resulted from the use of Aldo MO and Thermolec WFC Lecithin emulsifier in the treatment mixture. A cleaner, brighter and more natural appearance resulted from use of Yelkin 1018 Lecithin and Polysorbate 80. A golden cast was apparent on the non-green, non-decayed potatoes relatively soon after the treatment and remained for 5 days or more after the treatment. It is believed that the golden appearance is a result of using citric acid in the treatment mixture. The golden appearance may present a cleaner, fresher and more desirable appearance to customers, leading to the more favorable inclination for purchasing the potatoes.

The vacuum infusion appears to permit use of lesser effective concentrations of emulsifier and organic acid of the treatment mixture, compared to those concentrations described in U.S. Pat. Nos. 4,123,558 and 3,533,810. The higher effective concentration of emulsifier and citric acid described in U.S. Pat. Nos. 3,533,810 and 4,123,558 may also have induced decay, because some of the non-greening potatoes treated in connection with this invention were prone to a more rapidly development of decay when the aqueous treatment mixture contained higher effective concentrations of emulsifier (1.5% or greater) and citric acid (2.2% or greater).

The improvements and advantages of the present invention make the treated potatoes more useable as food, rather than requiring a significant percentage of the potatoes to be discarded in an inedible condition solely because of greening or decay. Less rotation of the potatoes in food markets and grocery stores is required, and lesser transportation costs are incurred. Many other advantages and improvements will become apparent upon fully appreciating ramifications and improvements of the present invention.

Preferred embodiments of the invention and many of its improvements have been described with the degree of particularity now known and understood. The description is of one or more preferred examples of implementing the invention. However, this detailed description is not necessarily intended to limit the scope of the invention. The scope of the invention is defined by the following claims.

The invention claimed is:

1. A process of inhibiting greening and decay of a potato by infusion into an outer layer of the potato of a treatment mixture comprising effective amounts of food-grade citric acid, food-grade emulsifier and food-grade salt mixed in water to inhibit greening and decay for at least 5 days after continuous exposure to light in room temperature display conditions.

2. A process as defined in claim 1, further comprising:
infusing the treatment mixture into the potato by vacuum infusion.

3. A process as defined in claim 2, further comprising:
infusing the treatment mixture into the potato by exposing the potato to the treatment mixture in a vacuum environment having pressure of about 84-90 Kpa less than ambient pressure.

4. A process as defined in claim 3, further comprising:
infusing the treatment mixture into the potato by cyclically dipping the potato in the treatment mixture and withdrawing the potato from the treatment mixture in the vacuum environment.

5. A process as defined in claim 4, further comprising:
completing the infusion in 2-8 minutes of cyclically dipping and withdrawing the potato.

6. A process as defined in claim 5, further comprising:
completing the infusion in 4 minutes or less of cyclically dipping and withdrawing the potato.

7. A process as defined in claim 2, further comprising:
infusing the treatment mixture into the layer of the potato to a depth of approximately 1-3 mm.

8. A process as defined in claim 1, further comprising:
formulating the treatment mixture from emulsifier in the amount of 0.5 to 1.4% by weight, citric acid in the amount of 0.9% to 2.1% by weight, salt in the amount of 0.4 to 1.1% by weight, and the balance from water.

9. A process as defined in claim 1, further comprising:
formulating the treatment mixture from emulsifier in the amount of 0.5 to 1.1% by weight, citric acid in the amount of 0.9% to 1.4% by weight, salt in the amount of 0.4 to 0.8% by weight, and the balance from water.

10. A process as defined in claim 1, further comprising:
formulating the treatment mixture from emulsifier in the amount of 0.7-0.9% by weight, citric acid in the amount of 1.2-1.4% by weight, salt in the amount of 0.5-0.8% by weight, and the balance from water.

11. A process as defined in claim 1, further comprising:
selecting the salt for the treatment mixture from one of the group consisting of sodium chloride, calcium chloride and potassium chloride; and

12. A process as defined in claim 1, further comprising:
selecting the emulsifier from one of the group consisting of a polar lipid emulsifier and a phospholipids emulsifier.

13. A process as defined in claim 1, further comprising:
selecting the citric acid from one of the group consisting of carboxylic acid of malic and monopotassium salt of tartaric.

14. A process as defined in claim 1, further comprising:
selecting the emulsifier from one of the group consisting of Thermolec WFC lecithin, Yelkin 1018 lecithin, Aldo MO emulsifier, Polysorbate 80, and mixtures thereof.

15. A process as defined in claim 1, further comprising:
formulating the aqueous treatment mixture from water containing ozone in the amount of 0.0005 to 0.001 ppm.

16. A process as defined in claim 1 for simultaneously treating a plurality of potatoes in a batch, wherein infusing the treatment mixture in the potatoes is performed in a treatment environment having a pressure substantially different from atmospheric pressure by:
loading the batch of potatoes in a basket;
placing the basket with the loaded batch of potatoes within the treatment environment;
placing the treatment mixture in the treatment environment; and
repetitively dipping the batch of potatoes in the basket into the treatment mixture and withdrawing the batch of potatoes in the basket from the treatment mixture in the treatment environment.

17. A process as defined in claim 16, further comprising:
applying a pressure of about 84-90 Kpa less than ambient atmospheric pressure in the treatment environment while dipping and withdrawing the batch of potatoes.

18. A process as defined in claim 1, further comprising:
washing the potatoes in ozonated water prior to infusion of the treatment mixture.

19. A process as defined in claim 18, further comprising:
using ozonated water which includes ozone in the amount of 0.0005 to 0.001 ppm.

20. A process as defined in claim 1, further comprising:
preparing the treatment mixture by completely dispersing the emulsifier in water of the treatment mixture before adding the citric acid and the salt.

21. A process as defined in claim 20, further comprising:
dispersing the emulsifier in a first quantity water which constitutes a lesser amount of the total water used in formulating the treatment mixture; and thereafter
adding a second quantity of water which constitutes the remaining amount of the total water used in the treatment mixture; and
adding the citric acid and the salt either simultaneously with or after the second quantity of water has been added.

22. A potato with inhibition to greening and decay processed in accordance with the process defined in claim 1.

23. A potato as defined in claim 22 which is one of either a fresh-crop potato or a storage-crop potato.
